(19) United States
(12) Patent Application Publication
(10) Pub. No.: US 2026/0291667 A1
(43) Pub. Date: Sep. 24, 2026

(54) SYSTEMS AND METHODS FOR OVERHEAD REDUCTION USING SUPERIMPOSED DMRS

(71) Applicant: InterDigital Patent Holdings, Inc., Wilmington, DE (US)

(72) Inventors: Mohamed Salah Ibrahim, Chesterbrook, PA (US); Yugeswar Deenoo Narayanan Thangaraj, Chalfont, PA (US); Akshay Malhotra, San Jose, CA (US); Ahmet Serdar Tan, London (GB)

(73) Assignee: InterDigital Patent Holdings, Inc., Wilmington, DE (US)

(21) Appl. No.: 19/086,531

(22) Filed: Mar. 21, 2025

(51) Int. Cl. H04L 5/00; H04L 25/02

(52) U.S. Cl. CPC H04L 5/0044; H04L 5/0051; H04L 25/0254

(57) ABSTRACT

A wireless transmit/receive unit (WTRU) may receive a transmission. The transmission may be a physical downlink shared channel (PDSCH) transmission. The transmission (e.g., PDSCH transmission) may include data and/or a superimposed demodulation reference signal (S-DMRS). S-DMRS and data may be multiplexed on the same resource (RE). The WTRU may determine a S-DMRS parameter, for example associated with the PDSCH transmission. The S-DMRS parameter may include a transmission power ratio of S-DMRS to data and/or an number of resources of a total number of resources associated with the PDSCH transmission (e.g., overlap factor) that comprise both data and S-DMRS. The WTRU may transmit an indication of the at least one S-DMRS parameter.

### BACKGROUND

Deep learning may include a class of machine learning (ML) algorithms that may employ artificial neural networks, for example Deep Neural Networks (DNNs). DNNs may be (e.g., loosely) inspired by biological systems. The DNNs may be a special class of ML models that may be inspired by the human brain. The input may be linearly transformed and/or pass through non-linear activation function multiple times. DNNs may include multiple layers. A (e.g., each) layer may include a linear transformation and/or a given non-linear activation function. The DNNs may be trained using the training data, for example via back-propagation algorithm. DNNs may be utilized in a variety of domains including, for example speech, vision, natural language, wireless communication, and/or etc., and/or for (e.g., various) ML settings, for example supervised, un-supervised, semi-supervised, and/or etc. Artificial intelligence (AI) machine learning (ML) based systems and methods may include realization of behaviors and/or conformance to requirements by learning based on data, for example without explicit configuration of sequence of steps of actions. Systems and methods may enable learning complex behaviors which may be difficult to specify and/or implement, for example using legacy methods.

### SUMMARY

A wireless transmit/receive unit (WTRU) may receive a transmission. The transmission may be a physical downlink shared channel (PDSCH) transmission. The transmission (e.g., PDSCH transmission) may include data and/or a superimposed demodulation reference signal (S-DMRS). S-DMRS and data may be multiplexed on the same resource (RE). The WTRU may determine a S-DMRS parameter, for example associated with the PDSCH transmission. The S-DMRS parameter may include a transmission power ratio of S-DMRS to data and/or an number of resources of a total number of resources associated with the PDSCH transmission (e.g., overlap factor) that comprise both data and S-DMRS. The WTRU may transmit an indication of the at least one S-DMRS parameter.

The WTRU may receive configuration information. The configuration information may include a (e.g., second) S-DMRS parameter. The (e.g., second) S-DMRS parameter may include a (e.g., second) transmission power ratio of S-DMRS to data, a (e.g., second) number of resources that comprise data and S-DMRS, an S-DMRS configuration type, and/or an S-DMRS feedback configuration. The WTRU may receive the PDSCH transmission based on the (e.g., second) S-DMRS parameter.

The transmission power ratio of S-DMRS to data may be based on a number of allocated resource blocks (RBs) or a predetermined value. The number of resources that comprise data and S-DMRS may be based on a number of allocated resource blocks (RBs) or an overlap format. The WTRU may measure a channel condition and/or compare the channel condition to a threshold. The determination of the at least one S-DMRS parameter may be based on the comparison of the channel condition to the threshold. The channel condition may include a Doppler value and/or a delay spread value.

The WTRU may receive configuration information. The configuration information may be based on the indication of the S-DMRS parameter. The WTRU may receive a PDSCH transmission based on the configuration information. The WTRU may use an artificial intelligence (AI) machine learning (ML) model to estimate a channel condition for resources, for example for the resources that comprise data and S-DMRS. The WTRU may transmit the indication of the S-DMRS parameter based on a predetermined change in a channel parameter. The PDSCH transmission may include a first resource including orthogonal DMRS (O-DMRS) and a second resource including data and S-DMRS.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example of DMRS based channel estimation and equalization with orthogonally multiplexed data and DMRS.

FIG. 3 is an example of a superimposed DMRS procedure.

FIG. 4 is an example PDSCH data structure with S-DMRS.

FIG. 5 is a flow chart of an example S-DMRS procedure.

FIG. 6 is an example of different modes.

### DETAILED DESCRIPTION

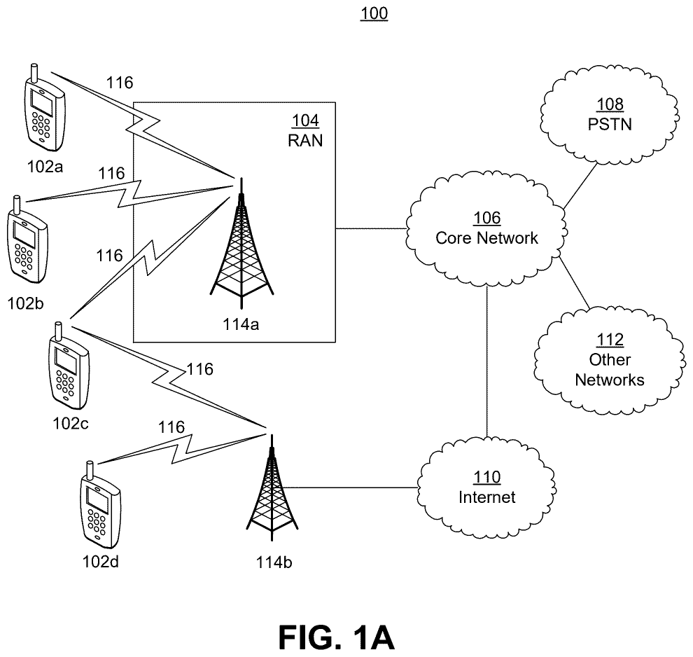

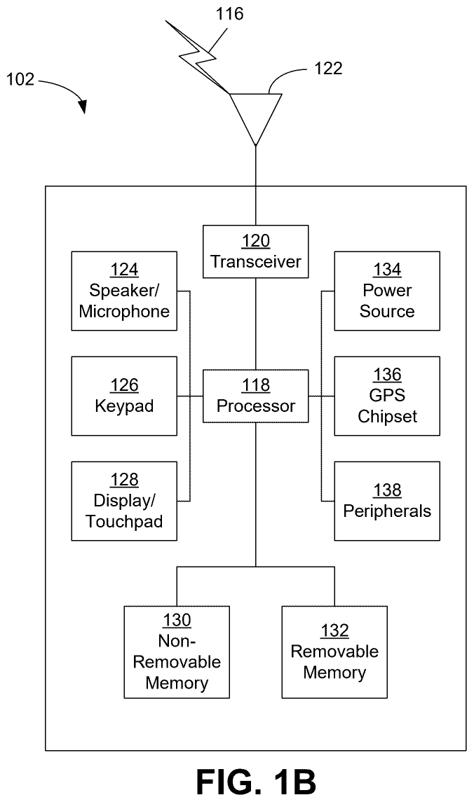

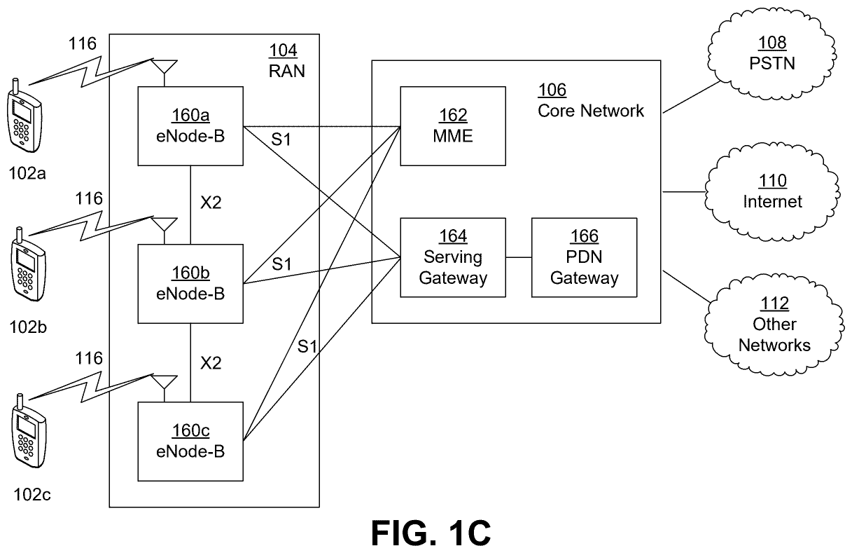

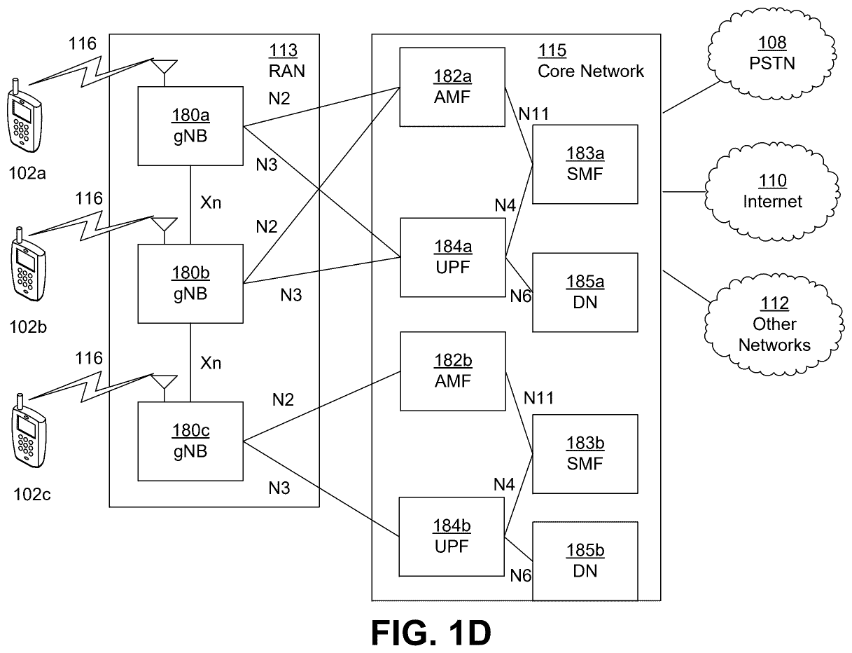

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods are provided for demodulation reference signals (DMRS). Coherent demodulation of signals transmitted over the radio interface may require knowledge of the (e.g., precoded and/or effective) wireless channel. A channel estimation process at the receiver in NR may rely on the transmission of physical channels accompanied with demodulation reference signals (DMRS). DMRSs may be generated using pseudo-random sequences, for example based on systems parameters known to the receiver. Configuration information (e.g., a configuration) of the DMRS may include one or more of density and/or pattern in the resource grid, a duration, a starting symbol (e.g., front-loaded DMRS), and/or cover code(s), for example with additional or alternative types for dealing with different channel scenarios.

There may be non-overlapping/orthogonal DMRS and data. DMRS and data may be orthogonally multiplexed in time and/or frequency. A system or method may (e.g., then) utilize DMRS, for example for channel estimation and/or coherent demodulation of the corresponding physical channels.

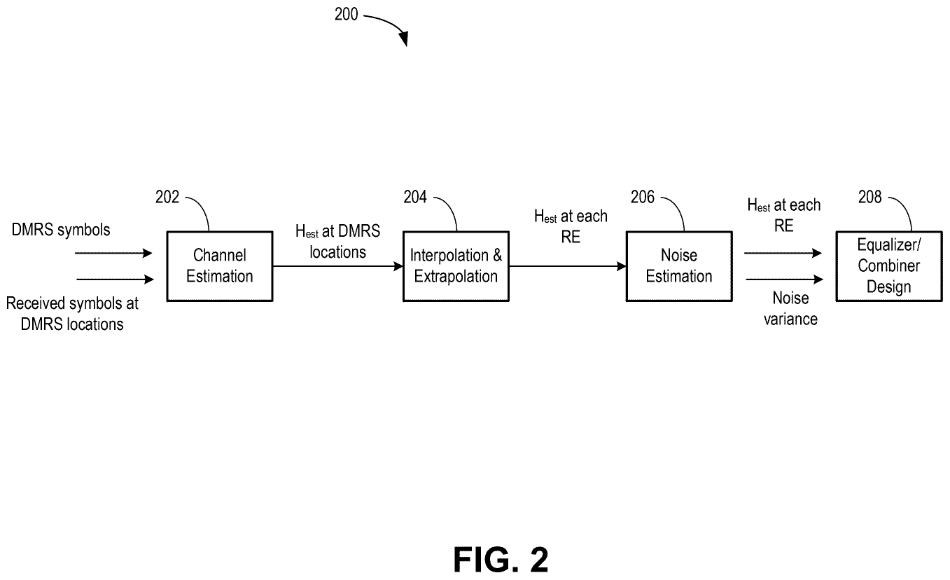

FIG. 2 is an example of DMRS based channel estimation and equalization 200 with orthogonally multiplexed data and DMRS. DMRS symbols and/or received symbols at DMRS locations may be input to a system, for example a WTRU. At 202 a receiver (e.g., the WTRU) may determine and/or estimate the channels of the DMRS symbols, for example from known locations in the received slots. An averaging window may be used, for example to minimize the effects of noise. At 204 a multi-dimensional interpolation and/or extrapolation operation may (e.g., then) be used, for example to estimate missing values associated with all the other resources (REs) from the channel estimation grid. At 206 noise power estimation may be performed, for example to improve performance by comparison of direct and/or average channel estimates. At 208 the WTRU (e.g., with the channel and noise estimates) may (e.g., then) design an equalizer (e.g., MMSE), for example followed by coherent OFDM demodulation of precoded/beamformed physical channels.

There may be overlapping/superimposed DMRS and data. Channel estimation quality may degrade, for example in highly-selective channel scenarios. Additionally, or alternatively, channel estimation quality may degrade at several RE locations, for example because of errors introduced interpolation/extrapolation (e.g., as in FIG. 2). Superimposed DMRS may (e.g., therefore) be used, for example where the data symbols and DMRS are both transmitted in (e.g., all) REs. Data symbols and DMRS may additionally or alternatively be transmitted with different power ratio(s).

The DMRS may be transmitted with (e.g., much) less power than the data. The terminal may (e.g., then) utilize high density DMRS and/or received data transmitted across (e.g., all) REs as an input, for example to derive the estimated channel at (e.g., all of) the REs. The high density DMRS may be configured to suppress the data term component, for example even when transmitted at low power relative to data. The DMRS suppressing the data term component may result in high-quality channel estimates. The superimposed DMRS approach may provide high-quality channel estimates relative to the non-overlapping DMRS, for example by overcompensating the errors introduced by interpolation (e.g., in challenging channel conditions). A terminal as herein may be a WTRU and/or a network (e.g., entity). Systems and methods herein may be described for uplink or downlink, but may be applicable for both uplink and downlink for example.

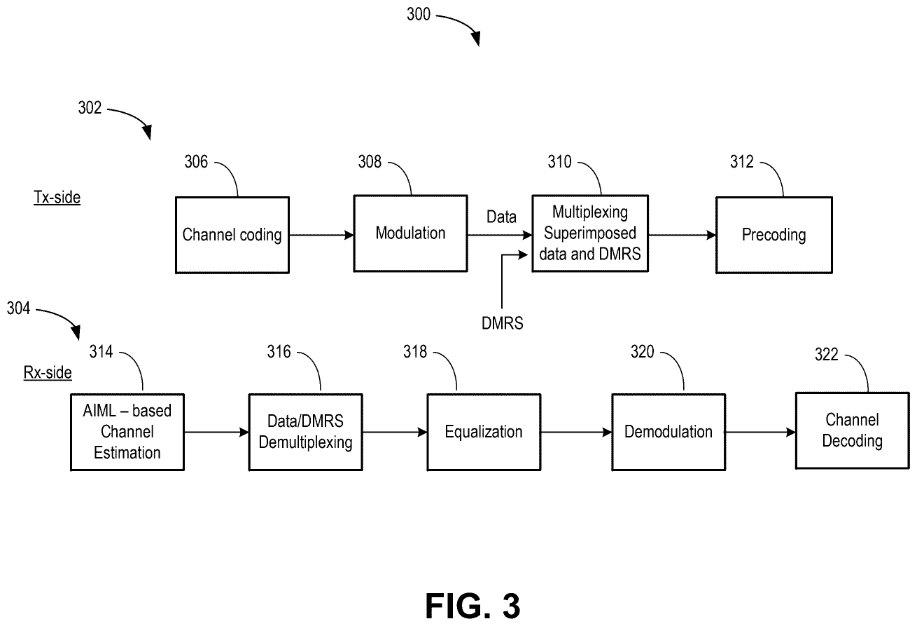

FIG. 3 is an example of a superimposed DMRS procedure 300. The example of superimposed DMRS may include a transmitter side 302 and/or a receiver side 304. The transmitter side 302 may be a WTRU and/or a network. The receiver side 304 may be a WTRU and/or a network. The transmitter side 302 may perform channel coding at 306. At 308 the transmitter side 302 may perform modulation, for example to output data. At 310 the transmitter side 302 may perform multiplexing, for example of superimposed data and DMRS. The DMRS may be received at the transmitter side 302 for the multiplexing. The transmitter side 302 may receive DMRS at and/or prior to 310. At 312 the transmitter side 302 may perform precoding.

The receiver side 304 may perform AIML-based channel estimation at 314. At 316 the receiver side 304 may perform demultiplexing of data and/or DMRS. At 318 the receiver side 304 may perform equalization. The receiver side 304 may perform demodulation at 320. At 322 the receiver side 304 may perform channel decoding.

Systems and methods may provide channel estimation, for example to equalize and/or demodulate data channels. The effective and/or precoded channel response to the receiver may be estimated by a WTRU using DMRS. The effective and/or precoded channel response may (e.g., then) be used for equalization and/or demodulation. Performance of the equalization process and/or the channel/link performance may be (e.g., directly) influenced by the quality of the channel estimate.

The channel may (e.g., first) be estimated at DMRS locations, for example where the data is absent. Interpolation and/or extrapolation may (e.g., then) be used to derive the estimated channel, for example at the remaining locations (e.g., with no DMRS). The channel quality at these (e.g., remaining) locations may be of less quality compared to the channels at the DMRS locations, for example because of the errors/uncertainties introduced by the interpolation/extrapolation (e.g., which may be more severe in highly-selective channel scenarios).

DMRS may be multiplexed with the data in (e.g., all) REs, for example prior to precoding. Additionally, or alternatively, DMRS may be multiplexed with different allocated power to the (e.g., each of the) DMRS and/or data, for example to obtain a specified (e.g., acceptable) performance. DMRS multiplexed with different allocated power to the (e.g., each of the) DMRS and/or data may be referred to as superimposed DMRS (S-DMRS). DMRS may be transmitted in (e.g., all) REs at (e.g., much) lower power than the data. The receiver may utilize the high density DMRS in the channel estimation, for example to overcome the power difference between the data and the DMRS. A superimposed DMRS approach may be more efficient, for example in scenarios where interpolation may introduce significant errors (e.g., highly selective channels).

There may be challenges associated with superimposed DMRS. Systems and methods may address the challenges, for example to obtain a desired channel estimation (CHEST) performance. A WTRU may determine superimposed DMRS parameters. DMRS parameters may include a superimposed power ratio (e.g., per sub-grid) and/or a superimposed overlap ratio. The WTRU may determine superimposed DMRS parameters to enable efficient superimposed DMRS transmission. The WTRU may determine a (e.g., appropriate) DMRS transmission mode. The DMRS transmission mode may include fully S-DMRS mode, partially S-DMRS mode, partially S-DMRS and/or orthogonal DMRS (O-DMRS) (e.g., legacy) mode, and/or O-DMRS (e.g., legacy) mode.

Systems and methods may provide for S-DMRS transmission and/or determination of parameters, for example at a WTRU. S-DMRS may enable high density DMRS transmission, which may for example result in improved decoding performance relative to O-DMRS transmission. Systems and methods may configure, receive, and/or process PDSCH with S-DMRS transmission(s). Additionally, or alternatively, systems and methods may determine superimposed DMRS parameters, for example for optimizing PDSCH performance.

A WTRU may be configured with one or more parameters, for example by configuration information (e.g., a configuration). The parameters may be associated with PDSCH with superimposed DMRS (S-DMRS). The configuration may include an S-DMRS configuration type, a configured power ratio (e.g., a %), a configured overlap factor (e.g., 3%), and/or a S-DMRS parameter(s) feedback configuration. The (e.g., configured) power ratio may be a transmission power ratio. The (e.g., configured) overlap factor may be a number of resources of a total number of resources (e.g., of the PDSCH transmission) that comprise both data and S-DRMS.

An S-DMRS configuration type may include S-DMRS type 1 and/or S-DMRS type 2. The S-DMRS configuration type may include an indication of the density of the overlapping S-DMRS in time and/or frequency. S-DMRS type 1 may map to a specific minimum density. S-DMRS type 1 and/or S-DMRS type 2 may utilize (e.g., consider) RE mapping of the S-DMRS.

A configured power ratio (e.g., a %) may include a (e.g., transmission) power ratio between S-DMRS relative to data symbols. The configured power ratio may be configured using a predefined/default configuration (e.g., a function of a number of allocated RBs) and/or a granular configuration (e.g., a set of defined values or set of increments/decrements relative to the default value).

A configured overlap factor (e.g., 3%) may include an overlap factor between S-DMRS and data symbols. The configured overlap factor may be configured using a predefined configuration (e.g., a function of a number of allocated RBs and/or reported channel conditions) and/or a granular overlap configuration. The granular overlap configuration may include a set of possible overlap formats. For example each format may be represented in terms of starting RE, size of the region and density, and/or pseudorandom-based generation. A S-DMRS parameter(s) feedback configuration may include trigger(s). Example triggers may be based on performance degradation and/or be time-based. The (e.g., configured) overlap factor may be a number of resources of a total number of resources (e.g., of the PDSCH transmission) that comprise both data and S-DRMS.

The WTRU may receive a PDSCH associated with S-DMRS transmission, for example using a first set of S-DMRS parameters. The PDSCH may include the S-DMRS. The transmission (e.g., S-DMRS transmission) may include a first group of REs carrying (e.g., only) data symbols, a second group of REs carrying superimposed DMRS symbols and data symbols, and/or a field in DCI to indicate the PDSCH format with S-DMRS transmission. The second group of REs carrying superimposed DMRS symbols and data symbols may be multiplexed with a different power ratio (e.g., based on configured value). The number of REs in the second group may be based on the configured overlap factor. For example 70% overlap may mean that the number of REs in the second group represents 70% of the allocated resources following the overlap configuration.

The WTRU may estimate the channel, for example using an AIML model. The WTRU may estimate the channel for the second group of REs. The AIML model may use as input the received signal at the second group of REs and/or the associated known DMRS. The WTRU may perform interpolation/extrapolation, for example to derive the channel estimates at the remaining REs. The WTRU may perform demultiplexing of the data and/or S-DMRS. The WTRU may decode the (e.g., desired) data symbols.

The WTRU may determine a second set of S-DMRS parameters for a second configuration. The second set of S-DMRS parameters may include a (e.g., preferred) power ratio and/or overlap factor. The (e.g., preferred) power ratio and/or overlap factor may be based on WTRU-based measurement(s) and/or a network (NW) configuration and/or (e.g., additional) WTRU measurement(s). For example the (e.g., preferred) power ratio and/or overlap factor may be based on NW configuration with additional WTRU measurement(s).

A WTRU-based measurement may include measured channel parameter(s) compared to a configured threshold, a measured Doppler and/or delay spread, higher/lower values (e.g., indicating higher/lower selectivity resulting in overlap increase/decrease and/or power ratio increase/decrease), a measured SGCS between the estimated channel difference between OFDM symbols (e.g., first and last) and/or between two different RBs (e.g., first and last), higher SGCS indicating lower overlap, a function of the computed BLER and/or number of erroneous code block groups, and/or a function of the AIML model (e.g., CHEST) performance.

The NW-configuration, for example with additional WTRU measurement(s) may include a function of the allocated bandwidth (BW) and/or measured signal interference level (e.g., a lower BW and high interference may indicate selection of high-power ratio to compensate the decrease in the number of overlapping REs), and/or a function of the number of reported layers along with measured interlayer interference (e.g., higher layers with higher interference may indicate increasing the power ratio and/or the overlap factor).

The WTRU may report the determined S-DMRS parameters (e.g., power ratio and/or overlap factor) based on the WTRU deriving a resource for reporting as a function of PDSCH resource and/or an indication in DCI. Additionally, or alternatively, the WTRU may report the determined S-DMRS parameters periodically (e.g., every n time units, slots, and/or ms) and/or aperiodically, for example when a configured trigger is satisfied (e.g., a change in measured channel parameters relative to a threshold) and/or when there is a CHEST model update. The WTRU may report the determined S-DMRS parameters based on HARQ-ACK feedback, for example implicitly or explicitly. The WTRU may receive an updated configuration, for example based on the reported S-DMRS parameters. The configuration may include one or more of the reported S-DMRS parameters. The WTRU may receive and/or process the PDSCH, for example with the updated configuration.

Systems and methods include a data channel structure, for example that may enable superimposed DMRS transmission and/or where the S-DMRS and the data may be sent (e.g., together) over the same REs. Systems and methods may describe a mobile terminal (e.g., WTRU, STA) configured to determine and/or report one or more aspects associated with the transmission and/or reception of the S-DMRS-based data channel.

S-DMRS may be used to indicate the superimposed DMRS multiplexed with the data symbols in the same REs, for example under a specific power ratio. The terms superimposed DMRS, overlapping DMRS, and non-orthogonal DMRS may be used interchangeably, for example to indicate the DMRS is transmitted/multiplexed with the data in the same REs. O-DMRS may refer to the legacy DMRS, for example which may be transmitted on specific REs that do not include data symbols. The terms orthogonal DMRS, non-overlapping, and legacy DMRS may be used interchangeably, for example to indicate the legacy DMRS which may be transmitted separately from the data on different REs.

Systems and methods may include configuration information (e.g., a configuration) of S-DMRS transmission and/or reception, for example for a physical channel with S-DMRS transmission. A physical channel may include PDSCH, PUSCH, PDCCH, PUCCH, PBCH, PRACH, and/or any side link channel. While systems and methods may be described for PDSCH as an example realization, the systems and methods may be applicable to any other physical channels.

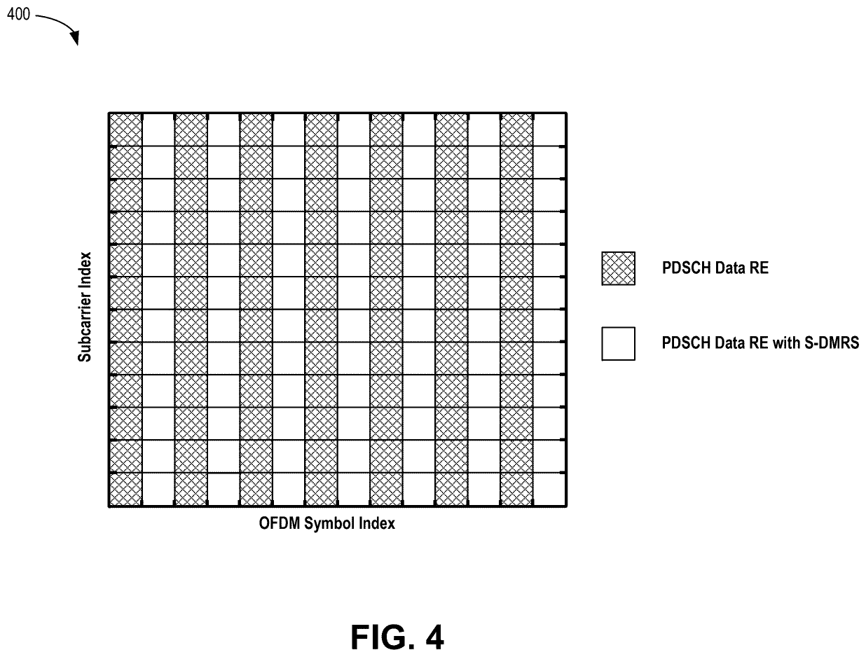

FIG. 4 is an example PDSCH data structure 400 with S-DMRS. A WTRU may be configured with PDSCH associated with a S-DMRS transmission. Data symbols and S-DMRS may be multiplexed in the power domain across (e.g., all) REs, which for example may result in minimal/negligible redundancy relative to legacy/non-overlapping DMRS transmission. The S-DMRS may be transmitted at a higher density, for example spanning (e.g., all) data REs and/or at a (e.g., much) lower power relative to the data REs. The PDSCH with S-DMRS transmission may include two groups of REs. The PDSCH with S-DMRS transmission may include a first group of REs carrying data symbols (e.g., only). Example PDSCH data REs are shown in the example PDSCH data structure 400. The PDSCH with S-DMRS transmission may include a second group of REs carrying superimposed DMRS symbols and data symbols, for example multiplexed with a different power ratio (e.g., based on configured value). The number of REs in the second group may be based on a configured overlap factor. Example PDSCH data REs with S-DMRS are shown in the example PDSCH data structure 400. The PDSCH transmission with S-DMRS may be indicated in a DCI field, for example as a new PDSCH format.

There may be sequence generation for the S-DMRS transmission. The S-DMRS may be transmitted across all data REs or only on a subset of data REs. To achieve orthogonality across the different layers with S-DMRS transmission for example, code division multiplexing (CDM) may be used to ensure inter-layer orthogonality of S-DMRS. The S-DMRS sequence may be generated similar to an O-DMRS sequence generation. The S-DMRS may be generated from a discrete Fourier transform (DFT) codebook. The number of REs occupied by S-DMRS may be divided into multiple CDM groups. The S-DMRS in a (e.g., each) CDM group may be quasi co-located.

There may be resource mapping. Resource mapping of the PDSCH S-DMRS may be configured using one or more parameters. A first configuration parameter may be for controlling a location pattern in frequency domain. A second configuration parameter may be for controlling a location pattern in time domain. For example, the first configuration parameter may indicate the start OFDM symbol. The second configuration parameter may indicate a start subcarrier index. The WTRU may determine (e.g., assume) that the PDSCH S-DMRS is mapped to physical resources, for example according to S-DMRS configuration type 1 and/or S-DMRS configuration type 2. The configuration type may be configured using a higher-layer parameter S-DMRS-Configuration-Type. The configuration type may be for controlling the S-DMRS pattern in the frequency domain. Type 1 may indicate a fully overlapping transmission between the PDSCH and S-DMRS. The fully overlapping transmission between the PDSCH and S-DMRS man span the (e.g., entire) REs within a RB in a specific OFDM symbol, for example resulting in a support of 12 DMRS ports. Type 2 may indicate a partial overlap between the PDSCH and S-DMRS, for example every other subcarrier within a RB in a specific OFDM symbol.

There may be a S-DMRS parameter(s) configuration. The WTRU may be configured with one or more S-DMRS configuration parameters. The parameters may include one or more of a configured power ratio and/or overlap factor. The power ratio a % may indicate the transmission power associated with the S-DMRS relative to the data. The power ratio may control the interference level on the data and/or impact the channel estimation performance. For example a (e.g., very) low power ratio may result in a low interference level on the data and/or make the channel estimation more challenging (e.g., especially if the overlap ratio is small).

The power ratio may be configured in a format including one or more of a default/initial value, an explicit configured value, and/or a granular configuration. For the default/initial value, if the WTRU is not configured with a specific power ratio value for example, the WTRU may determine (e.g., assume) that an applied power ratio is a default value (e.g., α=α_{d}). For the explicit configured value, the WTRU may be explicitly configured/indicated with a power ratio value. For the granular configuration, the WTRU may be configured with a δα relative to a reference/default value, for example where α=α_{d}±δα. The values of δα may additionally or alternatively be configured.

The WTRU may be configured with an overlap factor. The overlap factor may define the number of REs that contains S-DMRS and data relative to the total number of REs in the time-frequency grid. The WTRU may be configured with an initial/default overlap value percentage and/or a range, for example minimum and/or maximum values of allowed overlap between the data and S-DMRS. For example, the WTRU overlap may be implicitly configured as a function of the number of allocated RBs. A WTRU may be configured with a first range of overlap, for example if the allocated bandwidth is below a threshold. Additionally or alternatively the WTRU may be configured with a second range of overlap, for example if the allocated bandwidth is above a threshold.

The WTRU may be configured with different overlap formats. A first format may be indicated as a starting RE, a size of the region associated with the S-DMRS, and/or a density of the S-SMRS within a region. A second format may be indicated as a starting RE, an ending RE, and/or distance between a (e.g., every) pair of REs containing S-DMRS. A third format may be indicated as a starting RE, an ending RE, and/or a delta overlap, for example relative to a previous configuration. For example, the overlap may be generated using a pseudo-random seed.

There may be configuration information (e.g., a configuration) of S-DMRS feedback. A WTRU may be configured to indicate one or more parameters associated with S-DMRS. The WTRU may be configured to report one or more of the S-DMRS parameters periodically, semi-persistently, aperiodically, and/or upon meeting the trigger conditions. For example, the trigger condition may include a (e.g., predetermined) change in preferred overlap (e.g., by percentage) and/or a change in the preferred power ratio. Additionally, or alternatively, the trigger condition may include a change in a channel condition, for example by a predetermined (e.g., threshold) amount. The trigger condition may include a degradation in the PDSCH performance, for example block error rate (BLER) and/or number of consecutive NACKs. The WTRU may indicate one or more of the S-DMRS parameters, for example via uplink control information (UCI), in a PUSCH resource, and/or in a MAC CE.

There may be S-DMRS reception. The WTRU may be configured/indicated to process and/or decode S-DMRS based PDSCH. For example, the indication may be a DCI field indicating the new PDSCH format with S-DMRS transmission. For example different DCI formats may be used to implicitly indicate different S-DMRS parameterizations. A first PDSCH format may be used to indicate S-DMRS reception with a first overlap range, power ratio range, and/or S-DMRS type 1. A second PDSCH format may be used to indicate S-DMRS reception with a second overlap range, power ratio range, and/or S-DMRS type 2.

The WTRU may process the received PDSCH with S-DMRS transmission. The WTRU may estimate the effective channel (e.g., using AIML model), for example based on the received signal at the S-DMRS locations along with the known S-DMRS sequence. The WTRU may use the estimated channel to demultiplex the S-DMRS and/or PDSCH data symbol. The WTRU may perform data equalization, for example using the estimated effective channel and/or the demultiplexed data signal. The WTRU may be configured with different (e.g., AIML) CHEST models. For example a CHEST model (e.g., each model) may operate at a specific power ratio. For multilayer operation for example, the WTRU may apply successive interference cancellation mechanisms to mitigate the interference associated with S-DMRS and/or other layers.

Systems and methods may provide for superimposed DMRS (S-DMRS) transmission and/or determination of parameters, for example at a WTRU. The WTRU may determine one or more S-DMRS parameters. The WTRU may determine the S-DMRS parameters associated with the preferred power ratio, the overlap factor, and/or S-DMRS symbol placement, etc., for example based on WTRU measurement(s). The WTRU may utilize the measured channel parameters for the determination of the S-DMRS parameter(s) (e.g., evaluation). For example, the WTRU may utilize the measured Doppler and/or delay spread values. A high Doppler and/or a high delay spread may indicate a highly selective channel, for example where an increase in the overlap factor and/or an increase in the preferred power may be desired.

Additionally, or alternatively, if the channel has lower Doppler and/or a lower delay spread value for example, the channel may be less selective and/or include redundant information. The channel may be effectively estimated with lower configured values for power ratio and/or overlap factor. The preferred power ratio and/or overlap factor may be selected in proportion to the values of delay spread and/or Doppler. The power ratio and/or overlap factor may be selected based on predefined thresholds and/or ranges. Depending on the range within which the value of Doppler and/or delay spreads lies for example, a corresponding value for power ratio and/or overlap factor may be selected.

S-DMRS symbol placement may additionally or alternatively be function of and/or dependent on the channel selectivity (e.g., delay spread and/or Doppler etc.). If the channel is more frequency selective for example, the S-DMRS symbols may be placed along the frequency dimension across sub-carriers and/or the spread across time may be limited to only a few (e.g., a subset of) time symbols. Alternatively, or additionally, if the channel is more time selective for example, the S-DMRS symbols may be placed along the time dimension and/or across (e.g., all of) the time symbols. The spread across the frequency components may be limited to only a few (e.g., a subset of) sub-carriers. If the channel is both time and frequency selective for example, the S-DMRS symbols may be spread across all REs and/or may be spread in proportion to the time and/or frequency selectivity of the channel (e.g. in proportion to the ratio of Doppler to delay spread).

The WTRU may utilize (e.g., leverage) estimated channel matrices, for example based on CSI-RS (e.g., if configured). The WTRU may utilize (e.g., leverage) estimated channel matrices to determine the frequency and/or time selectivity, for example for determining the power ratio and the overlap factor. The WTRU may utilize a similarity metric (e.g. squared generalized cosine similarity (SGCS) and/or normalized mean squared error (NMSE), etc.), for example to determine the similarity or differences between the estimated channel across the frequency dimension (e.g., across the RBs or across sub-carriers) and/or across the time dimension (e.g., across the OFDM symbols).

The similarity may be evaluated between the first OFDM symbol and another OFDM symbol, for example all of the other OFDM symbols. Different weighted combinations and/or statistics associated with these values may be utilized, for example to determine the power ratio and/or the overlap factor. The mean of the similarities may be compared against different thresholds, for example to determine the power ratio and/or the overlap factor. Additionally, or alternatively, the similarity may be evaluated between the channel estimate associated with first resource block (RB) and another (e.g., all of the) neighboring RBs. Statistics (e.g. mean, variance) of the similarities may be compared against different thresholds, for example to determine the power ratio and the overlap factor.

The WTRU may compute different error rates (e.g. block error rate (BLER), bit error rate (BER), and/or number of erroneous code block groups, etc.). The WTRU may control the power ratio and/or the overlap factor as a function of this error rate, for example in proportion to the error rate). If the error rate is high for example, the power ratio and/or overlap factor may be increased. If the error rate is low for example, the power ratio and/or overlap factor may be decreased.

The WTRU may determine the power ratio and/or the overlap factor as a function of legacy channel estimation and/or AIML based channel estimation performance. The performance of the AIML based channel estimation may be compared against one or more predefined thresholds, for example to determine one or more values associated with the power ratio and/or overlap factor.

The WTRU may determine the S-DMRS parameters, for example the preferred power ratio, overlap factor, and/or S-DMRS symbol placement, etc. The WTRU may determine the S-DMRS parameters based on a NW-configuration and/or (e.g., additional) WTRU measurements. The S-DMRS parameters may be selected as a function of the allocated bandwidth and/or the measured signal interference level. For example where a high interference level is encountered and/or the overall allocated bandwidth is low, the WTRU may increase the power ratio to compensate for the interference and/or to compensate for the limited number of REs available for the superimposed DMRS.

The WTRU may determine the S-DMRS parameters as a function of the number of reported layers and/or the measured interlayer interference. For example as the number of layers with high interference increases, the power ratio and/or the overlap factor may also be increased. The power ratio and/or overlap factor may be selected inversely in proportion to the eigenvalues associated with each layer. The first layer corresponding to the highest eigenvalue for example, may have a lower power ratio and/or overlap factor. Layers corresponding to lower eigen values may have a higher power ratio and/or overlap factor.

The WTRU may report S-DMRS parameter(s). The WTRU may determine reporting resources, for example based on PDSCH allocation. The WTRU may be configured to receive DMRS in resource elements, for example shared/overlapped with PDSCH transmission (e.g., S-DMRS). The WTRU may determine one or more parameters associated with the shared/overlapped DMRS reception. The WTRU may report one or more parameters associated with the shared/overlapped DMRS reception to the network (e.g., gNB). The S-DMRS parameters may include parameters as described herein. The WTRU may report S-DMRS parameters in PUCCH, UCI, a MAC CE, and/or RRC message.

The WTRU may determine the resources for reporting S-DMRS parameters as a function of PDSCH resource allocation and/or indication in DCI. The WTRU may be preconfigured with a UL resource, for example that may be conditionally available based on a property of PDSCH. For example the WTRU may be preconfigured with UL resource at a preconfigured offset from the PDSCH carrying S-DMRS. The preconfigured offset may be in terms of time and/or frequency.

Upon receiving a PDSCH carrying S-DMRS in slot n and/or at starting RB m for example, the WTRU may determine (e.g., assume) that a UL resource for reporting S-DMRS parameters is available at slot n+x and/or at starting RB m+y. A size of the UL resource may be a function of a configured S-DMRS reporting configuration, for example including the size of the S-DMRS report. The value of x and/or y may be predefined. The value of x and/or y may be explicitly indicated in DCI. Additionally, or alternatively, the WTRU may determine the value of x and/or y as a function of the size of PDSCH. For example the WTRU may determine a first value of x for smaller PDSCH allocation and/or a second value of x for a larger PDSCH allocation. The size of UL grant for S-DMRS report may be explicitly indicated in DCI. The report format and/or contents of S-DMRS report may be explicitly indicated in DCI. The WTRU may determine (e.g., assume) that a UL resource for reporting S-DMRS parameters is not available, for example upon receiving a PDSCH (e.g., carrying legacy DMRS). For example upon receiving a PDSCH carrying legacy DMRS and/or an explicit indication in DCI for S-DMRS reporting, the WTRU may determine (e.g., assume) that a UL resource for reporting S-DMRS parameters is available.

The WTRU may be configured to report the S-DMRS parameters aperiodically, for example based on NW request and/or based on one or more preconfigured triggers. The WTRU may report S-DMRS parameters, for example upon receiving explicit indication in DCI (carrying PDSCH scheduling). For example, the explicit indication may provide a UL grant for reporting S-DMRS parameters. For the aperiodic report for example, the WTRU may determine (e.g., assume) the reference for S-DMRS parameter estimation is the PDSCH allocated by the DCI associated with the explicit indication. Additionally, or alternatively, the WTRU may determine (e.g., assume) the reference for S-DMRS parameter estimation is the last n PDSCHs allocated by the DCI associated with the explicit indication. The WTRU may determine (e.g., assume) the reference for S-DMRS parameter estimation is the PDSCHs received in the last t ms from the reception of DCI associated with the explicit indication.

The value of t and/or n may be predefined and/or may be indicated in the DCI. The WTRU may transmit a S-DMRS report, for example when the channel parameters change by more than a preconfigured threshold. For example the WTRU may report S-DMRS parameters when one or more conditions are satisfied. The condition may include when Doppler and/or delay spread changes by a preconfigured threshold, when time/frequency selectivity changes by a preconfigured threshold, when an allocated BW changes by a preconfigured threshold, when the accuracy of channel estimate changes by a preconfigured threshold, when the BLER changes by a preconfigured threshold, and/or when the number of spatial layers changes by a preconfigured threshold, etc. If the SGCS and/or any other distance metric between measured channels within a time window/interval is above a threshold for example, the WTRU may trigger a report of S-DMRS parameters. The value of time interval and/or threshold may be predefined and/or configured for a WTRU, for example via RRC and/or MAC signaling. The WTRU may transmit a S-DMRS report, for example when the number of HARQ NACKs within a time interval exceed a predefined and/or preconfigured threshold.

The WTRU may be configured to report the S-DMRS parameters explicitly and/or implicitly, for example in a HARQ feedback. The WTRU may be configured with a first type of HARQ codebook, for example that may be applied for legacy HARQ. Additionally, or alternatively, the WTRU may be configured with a second type of HARQ codebook, for example that may be applied for transmissions associated with S-DMRS. The second type of HARQ codebook may define HARQ feedback carrying the decoding status of a transport block and a corresponding indication related to S-DMRS parameters, for example the S-DMRS overlap ratio and/or S-DMRS power ratio.

A first code point in the second type of HARQ codebook may indicate a HARQ NACK and a request to increase S-DMRS overlap ratio and/or S-DMRS power ratio. A second code point in the second type of HARQ codebook may indicate a HARQ ACK and a request to decrease S-DMRS overlap ratio and/or S-DMRS power ratio. For example, a second code point in the second type of HARQ codebook may indicate a HARQ ACK and a request to keep S-DMRS overlap ratio and/or a S-DMRS power ratio the same (e.g., as before). Different code points may be defined to handle multiple code block groups and S-DMRS parameter combinations.

The WTRU may be configured to determine the resource for S-DMRS report, for example as a function of UL resource for HARQ transmission. For example the WTRU may be configured to report S-DMRS in a UL resource at a preconfigured offset in terms of time and/or frequency from UL resource selected for HARQ feedback. The offset values may be predefined and/or may be indicated in the DCI.

The WTRU may be configured to report the S-DMRS parameters periodically. For example the WTRU may be configured with periodic/semi-persistent UL resources to report S-DMRS parameters. Periodic/semi-persistent UL resources may be configured via RRC signaling. The WTRU may receive a MAC control element activating/deactivating the UL resources for reporting S-DMRS parameters. The WTRU may receive implicit signals that a periodic and/or semi-persistent UL resource for reporting that S-DMRS is applicable/active. For example the WTRU may determine (e.g., assume) that the periodic and/or semi-persistent UL resources are available for S-DMRS reporting if the DCI allocates PDSCH with S-DMRS. The WTRU may determine (e.g., assume) that the periodic and/or semi-persistent UL resources are not available for S-DMRS reporting, for example if the DCI allocates PDSCH with legacy DMRS. The WTRU may be configured with PUCCH resources for reporting. The WTRU may be configured to report S-DMRS parameters as part of CSI feedback reporting. For example the WTRU may include the type and/or size of S-DMRS parameters in CSI feedback in a first part of the CSI report. Additionally, or alternatively, the WTRU may include the actual values of S-DMRS parameters in the second part of the CSI report.

The WTRU may receive an updated S-DMRS configuration for example using systems and methods described herein. The WTRU may receive the updated configuration based on the reported S-DMRS parameters. The configuration may include one or more of the reported S-DMRS parameters. The WTRU may process the received S-DMRS using systems and methods as described herein.

Systems and methods for superimposed DMRS mode selection are provided, for example at a WTRU. There may be a WTRU configuration of one or more S-DMRS mode. The WTRU may be configured with one or more DMRS transmission modes. The DMRS transmission mode may include one of a fully superimposed DMRS mode, a partially superimposed DMRS mode, a partially superimposed DMRS and orthogonal DMRS mode, and/or an orthogonal DMRS mode. The WTRU in the fully superimposed DMRS mode may transmit and/or multiplex S-DMRS with the data, for example on (e.g., all) PDSCH REs. The WTRU in the partially superimposed DMRS mode may transmit and/or multiplex S-DMRS with the data on a subset of the PDSCH REs and/or the remaining REs may carry data symbols (e.g., only). The WTRU in the partially superimposed DMRS and orthogonal (e.g., legacy) DMRS mode may transmit and/or multiplex S-DMRS with the data on a first subset of the PDSCH REs. Additionally, or alternatively, the WTRU in the partially superimposed DMRS and orthogonal (e.g., legacy) DMRS mode may transmit the orthogonal DMRS on a second subset of PDSCH REs and/or transmit the PDSCH data without DMRS on a third subset of REs. The WTRU in the orthogonal (e.g., legacy) DMRS mode may transmit data and DMRS separately on different REs.

A (e.g., each) DMRS transmission mode may be associated with a reception scheme. For example the fully superimposed DMRS mode may utilize a first AIML receiver for channel estimation at (e.g., all) RE locations. The partially superimposed DMRS mode may utilize a second AIML receiver for channel estimation at RE location(s) with S-DMRS and/or the WTRU may (e.g., then) interpolate/extrapolate to estimate the channel at the remaining RE(s). The partially superimposed DMRS and orthogonal (e.g., legacy) DMRS may utilize a third AIML model, for example that may use the estimated channel from legacy DMRS as (e.g., additional) input information to the AIML model for channel estimation. The orthogonal (e.g., legacy) DMRS mode may use legacy/non-AIML receiver for channel estimation.

The configured transmission mode may be indicated in a DCI field in the scheduling DCI for PDSCH transmission and/or indicated through RRC message and/or MAC CE. The configured transmission mode may be indicated as an index mapping to a pointer in a table. The WTRU may be configured with the transmission mode, for example when there is a change/update in the indicated mode. If the WTRU is not configured with a transmission mode for example, the WTRU may (e.g., then) determine (e.g., assume) that there is no mode change and/or that the configured mode from a previous transmission is still applicable to upcoming transmission(s).

The WTRU may be configured with a DMRS transmission mode and/or associated parameters. The configuration parameters associated with the partially/fully S-DMRS mode may be as described herein. For the mode associated with the partially S-DMRS and orthogonal (e.g., legacy) DMRS for example, the WTRU may be configured with a multimode multiplexing ratio parameter. The multimode multiplexing ratio parameter may define multiplexing ratio between partially S-DMRS and O-DMRS. The multiplexing ratio may be configured as a set of predefined values. A (e.g., each) predefined value may be associated with a defined configuration for (e.g., both) S-DMRS and/or orthogonal (e.g., legacy) DMRS. A first value may indicate front-loaded DMRS followed by S-DMRS in the subsequent REs for example. A second value may indicate S-DMRS transmitted first followed by orthogonal (e.g., legacy) DMRS in the remaining REs.

The WTRU may be configured with conditions/criterions, for example to enable multimode operation and/or preferred DMRS mode selection. The criterion may be based on Doppler and/or delay spread threshold. The criterion may be based on a squared generalized cosine similarity (SGCS) measurement between different CSI samples in different locations and/or a comparison against a threshold. The criterion may be based on a configured metric relation to channel selectivity, for example a correlation level between contiguous CSI samples.

The WTRU may determine a mode and/or associated parameters. For example, the WTRU may determine a preferred mode and/or associated parameters. A WTRU, for example capable of superimposed DMRS, may receive a PDCCH/PDSCH transmission with a first DMRS mode. The first mode may be fully superimposed DMRS, partially superimposed DMRS, partially superimposed and orthogonal DMRS, and/or fully orthogonal DMRS. The WTRU may determine the first DMRS mode, for example based on a field in the DCI indicating the one of multiple PDSCH formats based on the configured mode. The WTRU may additionally or alternatively receive a first set of parameters associated with the determined first DMRS mode. The first set of parameters may indicate the power ratio a %, the overlap factor 3%, and/or the O-DMRS density configurations, for example based on the determined first DMRS mode.

The WTRU may decode the received PDSCH, for example associated with the first DMRS transmission mode. The WTRU may decode the received PDSCH based on the first set of parameters. The WTRU may compute the channel, for example during the decoding process. For example, the WTRU may compute the estimated channel coefficients for one more of the associated resource elements (REs). The WTRU may additionally or alternatively measure the channel conditions and/or performance, for example Doppler, and/or BLER, etc. The WTRU may measure the channel estimation performance of the AIML model, for example if the WTRU uses AIML based CHEST. The WTRU may perform (e.g., all) measurements separately for each layer.

The WTRU may determine the preferred DMRS mode for a (e.g., each) layer, for example based on measured channel condition(s), measured SGCS for time selectivity, measured SGCS for frequency selectivity, allocated BW, AIML-based CHEST performance, a number of layers, block error rate (BLER), and/or an explicit indication.

The WTRU may determine the preferred DMRS mode for a (e.g., each) layer based on measured channel condition(s). The WTRU may compare measured channel conditions (e.g., Doppler and/or delay spread) against configured thresholds. If the measured channel condition(s) (e.g., Doppler and/or delay spread) is below a threshold, this for example may indicate low channel selectivity and/or the WTRU may determine O-DMRS mode as the preferred DMRS mode. The WTRU may (e.g., otherwise) determine to use superimposed DMRS modes. If for example the measured channel condition(s) (e.g., Doppler and/or delay spread) is higher than a second threshold, the WTRU may (e.g., then) determine fully S-DMRS mode.

The WTRU may determine the preferred DMRS mode for a (e.g., each) layer based on measured SGCS for time selectivity. The WTRU may compute the SGCS between the estimated channel at the last OFDM symbol and the first OFDM symbol, for example to measure the time selectivity of the channel. The WTRU may compare the measured SGCS with a configured threshold. If for example the measured SGCS is below a configured threshold (e.g., high time selectivity), the WTRU may (e.g., then) determine fully S-DMRS mode.

The WTRU may determine the preferred DMRS mode for a (e.g., each) layer based on measured SGCS for frequency selectivity. The WTRU may measure the SGCS between the nth RB and the n+N-th RB, for example based on quasi co-located CSI-RS and/or DMRS to measure the frequency selectivity of the channel. The WTRU may compare the measured SGCS with a configured threshold. If the measured SGCS is above a configured threshold (e.g., low frequency selectivity) for example, the WTRU may (e.g., then) determine O-DMRS mode.

The WTRU may determine the preferred DMRS mode for a (e.g., each) layer based on an allocated BW. The WTRU may determine the DMRS mode based on the allocated BW for transmission. If the allocated BW is below a threshold for example, the WTRU may (e.g., then) determine an O-DMRS mode. For example the number of S-DMRS may be insufficient to compensate the low power ratio which limits the use of S-DMRS.

The WTRU may determine the preferred DMRS mode for a (e.g., each) layer based on AIML-based CHEST performance. The WTRU may determine the DMRS mode based on the AIML-based CHEST performance. If the AIML-based CHEST performance (e.g., accuracy of the channel estimator) is below a threshold for example, the WTRU may (e.g., then) determine to use a mode that includes O-DMRS (e.g., S-DMRS and/or orthogonal DMRS and/or orthogonal DMRS) to improve the CHEST performance with legacy channel estimation.

The WTRU may determine the DMRS mode based on a number of layers. The WTRU may determine the DMRS mode based on the number of reported layers, for example as interference level may increase with a higher number of layers. If the number of layers is higher than a configured threshold (e.g., 2) for example, the WTRU may (e.g., then) determine O-DMRS based modes (e.g., S-DMRS and/or orthogonal DMRS and/or orthogonal DMRS) to decrease the impact of interference.

The WTRU may determine the preferred DMRS mode for a (e.g., each) layer based on BLER. The WTRU may determine the DMRS mode based on a computed historical BLER and/or the successfully decoded code blocks and/or code block groups. For example if the first DMRS mode is S-DMRS based (e.g., fully superimposed DMRS mode and/or partially superimposed DMRS mode) and/or the BLER is above a configured threshold, the WTRU may (e.g., then) determine to change the DMRS mode to O-DMRS (e.g., S-DMRS and/or orthogonal DMRS and/or orthogonal DMRS). If the first DMRS mode is O-DMRS-based for example (e.g., S-DMRS and/or orthogonal DMRS and/or orthogonal DMRS) and/or the BLER is above a configured threshold, the WTRU may (e.g., then) determine to change the DMRS mode to fully superimposed DMRS mode and/or partially superimposed DMRS mode.

The WTRU may determine the preferred DMRS mode for a (e.g., each) layer based on an explicit indication. The WTRU may determine the DMRS transmission mode based on the explicit indication by the NW, for example in the DCI.

The WTRU may determine the parameter(s) associated with the determined DMRS transmission mode, for example based on the determined mode. The WTRU may determine that the mode is fully superimposed DMRS mode. If the WTRU determines that the mode is fully superimposed DMRS mode for example, the WTRU may determine the power ratio. The WTRU may determine the power ratio based on Doppler and/or delay spread, channel selectivity, and/or estimated interference level.

The WTRU may determine the power ratio based on Doppler and/or delay spread. The WTRU may determine a higher power ratio for higher Doppler. The WTRU may use a (e.g., any) configured function and/or a look-up table to determine the power ratio, for example for a given Doppler and/or delay spread. The WTRU may determine the power ratio based on channel selectivity. The WTRU may determine a higher power ratio for higher channel selectivity. The WTRU may use a (e.g., any) configured function and/or a look-up table to determine the power ratio for a given channel selectivity. The WTRU may determine the power ratio based on an estimated interference level. The WTRU may determine the power ratio based on estimated interference level, for example where the interference level may be impacted by allocated BW, CHEST performance, number of layers, and/or BLER, etc. The WTRU may use a (e.g., any) configured function and/or a look-up table to determine the power ratio for a given estimated interference level.

The WTRU may use systems and methods as discussed herein, for example based on the determined mode. The WTRU may determine power ratio and/or overlap factor for S-DMRS and/or a multiplexing ratio (MR) that represents S-DMRS/O-DMRS, for example if the mode is S-DMRS (e.g., partially S-DMRS) and/or orthogonal DMRS. The WTRU may determine power ratio and/or overlap factor based on channel selectivity. The WTRU may determine a higher MR (e.g., lower O-DMRS allocations), for example if the channel selectivity is high. The WTRU may determine power ratio and/or overlap factor based on available CPUs. The WTRU may reduce MR (e.g., higher O-DMRS allocations), for example if there are lower CPUs available. Additionally, or alternatively, the WTRU may reduce MR due to the additional computational cost of the additional S-DMRS allocations and/or the AIML CHEST model needed to estimate the channel based on S-DMRS. The WTRU may determine power ratio and/or overlap factor based on a latency requirement. The WTRU may determine lower MR (e.g., with higher front-loaded O-DMRS), for example if the required latency is low.

A WTRU may report the S-DMRS mode and/or associated parameters. The WTRU may be configured to receive PDSCH in resource elements with one or more DMRS transmission mode. The DMRS mode may be associated with the presence and/or absence of legacy DMRS, and/or a level of overlap with S-DMRS (e.g., partial or fully overlapped), etc. The WTRU may determine one or more parameters associated with the DMRS transmission mode. The WTRU may report one or more parameters associated with the DMRS transmission mode, for example to the network (e.g., gNB). The DMRS transmission mode may include parameters for example as described herein. The WTU may report the DMRS transmission mode in PUCCH, UCI, MAC CE, and/or an RRC message.

The WTRU may determine the resources for reporting DMRS transmission mode parameters as a function of PDSCH resource allocation and/or indication in DCI. The WTRU may be preconfigured with a UL resource, for example that may be (e.g., conditionally) available based on a property of PDSCH. The WTRU may be preconfigured with a UL resource at a preconfigured offset from the PDSCH carrying non-legacy DMRS for example. An offset may be in terms of time and/or frequency. Upon receiving a PDSCH carrying S-DMRS in slot n and/or at starting RB m for example, the WTRU may determine (e.g., assume) that a UL resource for reporting DMRS transmission mode parameters may be available at slot n+x and/or at starting RB m+y.

A size of the UL resource may be a function of configured DMRS mode reporting configuration, which for example may include the size of the DMRS mode report. The value of x and y may be predefined. Additionally, or alternatively, the value of x and y may be explicitly indicated in DCI. The WTRU may determine the value of x and y as a function of the size of PDSCH. For example the WTRU may determine a first value of x for smaller PDSCH allocation and/or a second value of x for a larger PDSCH allocation. The size of a UL grant for DMRS transmission mode report may be explicitly indicated in DCI. The report format and/or contents of DMRS transmission mode report may be explicitly indicated in DCI. The WTRU may determine (e.g., assume) that a UL resource for DMRS transmission mode parameters is not available upon receiving a PDSCH carrying legacy. The WTRU may determine (e.g., assume) that a UL resource for reporting DMRS transmission mode parameters is available, for example upon receiving a PDSCH carrying legacy DMRS and/or an explicit indication in DCI for DMRS transmission mode.

The WTRU may be configured to report the DMRS transmission mode parameters aperiodically, for example based on a NW request and/or based on one or more preconfigured triggers. The WTRU may report DMRS transmission mode parameters, for example upon receiving explicit indication in DCI (e.g., carrying PDSCH scheduling). The explicit indication may additionally or alternatively provide a UL grant for reporting DMRS transmission mode. The WTRU may determine (e.g., assume) that the reference for DMRS transmission mode estimation is the PDSCH allocated by the DCI associated with the explicit indication, for example for the aperiodic report. The WTRU may determine (e.g., assume) the reference for DMRS transmission mode parameter estimation is the last n PDSCHs allocated by the DCI associated with the explicit indication.

The WTRU may determine (e.g., assume) the reference for DMRS transmission mode parameter estimation is the PDSCHs received in the last t ms from the reception of DCI associated with the explicit indication. The value of t and/or n may be predefined and/or may be indicated in the DCI. The WTRU may transmit a DMRS transmission mode report, for example when the channel parameters change more than a preconfigured threshold. For example the WTRU may report DMRS transmission mode parameters when one or more conditions are satisfied.

The condition may include when Doppler and/or delay spread changes by a preconfigured threshold, when time/frequency selectivity changes by a preconfigured threshold, when an allocated BW changes by a preconfigured threshold, when the accuracy of channel estimate changes by a preconfigured threshold, when the BLER changes by a preconfigured threshold, and/or when the number of spatial layers changes by a preconfigured threshold, etc. If the SGCS and/or any other distance metric between measured channels within a time window/interval is above a threshold for example, the WTRU may trigger a report of DMRS parameters. The value of time interval and/or threshold may be predefined and/or configured for a WTRU, for example via RRC and/or MAC signaling. The WTRU may transmit a DMRS report, for example when the number of HARQ NACKs within a time interval exceed a predefined and/or preconfigured threshold.

The WTRU may be configured to report the DMRS parameters explicitly and/or implicitly, for example in a HARQ feedback. The WTRU may be configured with a first type of HARQ codebook, for example that may be applied for legacy HARQ. Additionally, or alternatively, the WTRU may be configured with a second type of HARQ codebook, for example for transmission associated with S-DMRS. The second type of HARQ codebook may define HARQ feedback carrying the decoding status of transport block and a corresponding indication related to DMRS transmission mode parameters (e.g., the preferred DMRS transmission mode for example, partially S-DMRS, O-DMRS, fully S-DMRS).

A first code point in the second type of HARQ codebook may indicate a HARQ NACK and/or preferred DMRS mode as partially S-DMRS. A second code point in the second type of HARQ codebook may indicate a HARQ ACK and/or a preferred DMRS mode as fully S-DMRS. A second code point in the second type of HARQ codebook may indicate a HARQ ACK and/or a request to keep DMRS mode same (e.g., as before). Different code points may be defined to handle multiple code block groups and/or different DMRS transmission mode parameter combinations. The WTRU may be configured to determine the resource for DMRS transmission mode report as a function of a UL resource for HARQ transmission. The WTRU may be configured to report DMRS transmission mode in a UL resource at a preconfigured offset in terms of time and/or frequency from a UL resource selected for HARQ feedback. The offset values may be predefined and/or may be indicated in the DCI.

The WTRU may be configured to report the DMRS transmission mode parameters periodically. The WTRU may be configured with periodic/semi-persistent UL resources to report DMRS transmission mode parameters. Periodic/semi-persistent UL resources may be configured via RRC signaling. The WTRU may receive a MAC control element activating/deactivating the UL resources for reporting DMRS transmission mode parameters.

The WTRU may receive implicit signal(s) that a periodic and/or semi-persistent UL resource for reporting DMRS transmission mode is applicable/active. The WTRU may determine (e.g., assume) that the periodic and/or semi-persistent UL resources are available for DMRS transmission mode reporting, for example if the DCI allocates PDSCH with non-legacy DMRS transmission mode. The WTRU may determine (e.g., assume) that the periodic and/or semi-persistent UL resources are not available for DMRS transmission mode reporting, for example if the DCI allocates PDSCH with legacy DMRS. The WTRU may be configured with PUCCH resources for reporting. The WTRU may be configured to report DMRS transmission mode parameters as part of CSI feedback reporting. For example the WTRU may include the type and/or size of DMRS transmission mode parameters in CSI feedback in a first part of the CSI report and/or the (e.g., actual) values of DMRS transmission mode parameters in a second part of the CSI report.

The WTRU may receive an updated DMRS transmission mode configuration, for example using systems and methods described herein. The WTRU may receive the updated configuration, for example based on the reported DMRS transmission mode parameter(s). The configuration may include one or more of the reported S-DMRS parameters. The WTRU may process the received S-DMRS using systems and methods as described herein.

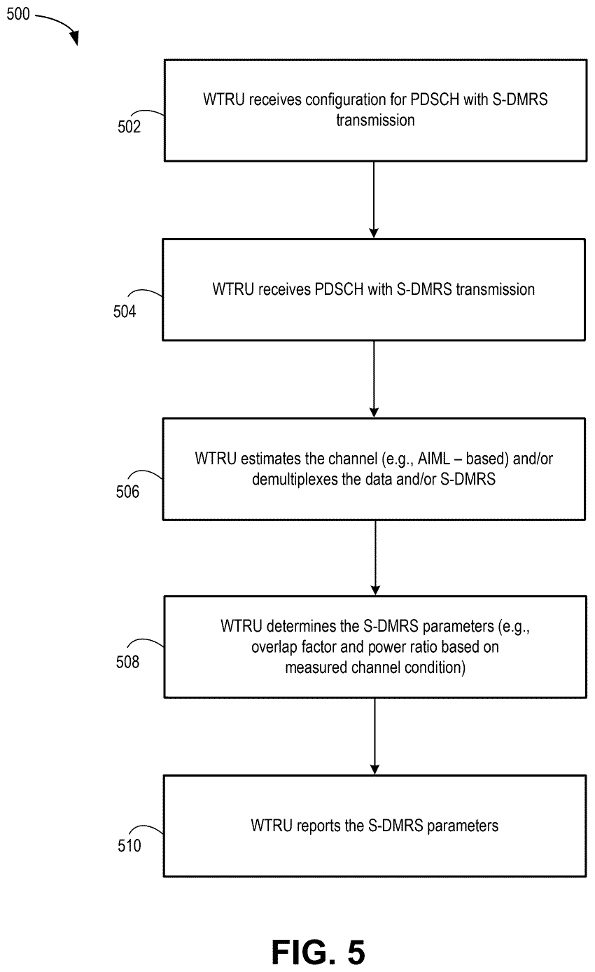

FIG. 5 is a flow chart of an example S-DMRS procedure 500. The procedure 500 may provide for S-DMRS transmission and/or determination of parameters, for example at a WTRU. At 502 a WTRU may receive configuration information (e.g., a configuration) for PDSCH with S-DMRS transmission. The WTRU may be configured with one or more parameters. The parameters may be associated with the PDSCH with S-DMRS. The configuration may include an S-DMRS configuration type, a configured power ratio (e.g., a %), a configured overlap factor (e.g., 3%), and/or a S-DMRS parameter(s) feedback configuration.

An S-DMRS configuration type may include S-DMRS type 1 and/or S-DMRS type 2, The S-DMRS configuration type may include an indication of the density of the overlapping S-DMRS in time and/or frequency. S-DMRS type 1 may map to a specific minimum density. S-DMRS type 1 and/or S-DMRS type 2 may utilize (e.g., consider) RE mapping of the S-DMRS.

A configured power ratio (e.g., a %) may include a (e.g., transmission) power ratio between S-DMRS relative to data symbols. The configured power ratio may be configured using a predefined/default configuration (e.g., a function of a number of allocated RBs) and/or a granular configuration (e.g., a set of defined values or set of increments/decrements relative to the default value).

A configured overlap factor (e.g., (%) may include an overlap factor between S-DMRS and data symbols. The (e.g., configured) overlap factor may be a number of resources of a total number of resources (e.g., of the PDSCH transmission) that comprise both data and S-DRMS. The configured overlap factor may be configured using a predefined configuration (e.g., a function of a number of allocated RBs and/or reported channel conditions), a granular overlap configuration, and/or a S-DMRS parameters feedback configuration. The granular overlap configuration may include a set of possible overlap formats. For example each format may be represented in terms of starting RE, size of the region and density, and/or pseudorandom-based generation. An S-DMRS parameter(s) feedback configuration may include trigger(s). Example triggers may be based on performance degradation and/or be time-based.

At 504 the WTRU may receive a PDSCH associated with S-DMRS transmission, for example using a first set of S-DMRS parameters. The transmission (e.g., S-DMRS transmission) may include a first group of REs carrying (e.g., only) data symbols, a second group of REs carrying superimposed DMRS symbols and data symbols, and/or a field in DCI to indicate the PDSCH format with S-DMRS transmission. The second group of REs carrying superimposed DMRS symbols and data symbols may be multiplexed with different a power ratio (e.g., based on configured value). The number of REs in the second group may be based on the configured overlap factor. For example 70% overlap may mean that the number of REs in the second group represents 70% of the allocated resources following the overlap configuration.

At 506 the WTRU may estimate the channel, for example using AIML model. The WTRU may estimate the channel for the second group of REs. The AIML model may use as an input the received signal at the second group of REs and/or the associated known DMRS. The WTRU may perform interpolation/extrapolation, for example to derive the channel estimates at the remaining REs. The WTRU may perform demultiplexing of the data and/or S-DMRS. The WTRU may decode the (e.g., desired) data symbols.

At 508 the WTRU may determine a second set of S-DMRS parameters for a second configuration. The second set of S-DMRS parameters may include a (e.g., preferred) power ratio (e.g., transmission power ratio) and/or overlap factor. The (e.g., preferred) power ratio and/or overlap factor may be based on WTRU-based measurement(s) and/or a network (NW) configuration and/or (e.g., additional) WTRU measurement(s). For example the (e.g., preferred) power ratio and/or overlap factor may be based on NW configuration with additional WTRU measurement(s).

A WTRU-based measurement may include measured channel parameter(s) compared to a configured threshold, a measured Doppler and/or delay spread, higher/lower values (e.g., indicating higher/lower selectivity resulting in overlap increase/decrease and/or power ratio increase/decrease), a measured SGCS between the estimated channel difference between OFDM symbols (e.g., first and last) and/or between two different RBs (e.g., first and last), higher SGCS indicating lower overlap, a function of the computed BLER and/or number of erroneous code block groups, and/or a function of the AIML model (e.g., CHEST) performance.

The NW-configuration, for example with additional WTRU measurement(s) may include a function of the allocated bandwidth (BW) and/or measured signal interference level (e.g., a lower BW and high interference may indicate selection of high-power ratio to compensate the decrease in the number of overlapping REs), and/or a function of the number of reported layers along with measured interlayer interference (e.g., higher layers with higher interference may indicate increasing the power ratio and/or the overlap factor).

At 510 the WTRU may report the determined S-DMRS parameters (e.g., power ratio and/or overlap factor) based on the WTRU deriving a resource for reporting as a function of PDSCH resource and/or an indication in DCI. The WTRU may transmit an indication of one or more S-DMRS parameters, for example to a network. Additionally, or alternatively, the WTRU may report the determined S-DMRS parameters periodically (e.g., every n time units, slots, and/or ms) and/or aperiodically, for example a configured trigger is satisfied (e.g., a change in measured channel parameters relative to a threshold), and/or when there is a CHEST model update. The WTRU may report the determined S-DMRS parameters based on HARQ-ACK feedback, for example implicitly or explicitly. The WTRU may receive an updated configuration, for example based on the reported S-DMRS parameters. The configuration may include one or more of the reported S-DMRS parameters. The WTRU may receive and/or process the PDSCH, for example with the updated configuration.

Systems and methods for superimposed DMRS mode selection are provided, for example at a WTRU. S-DMRS may be beneficial in scenarios with moderate to high channel selectivity. Orthogonal DMRS may be appropriate for flat channel setups. Different DMRS modes including superimposed DMRS and/or orthogonal DMRS may be appropriate for different scenarios. Systems and methods are provided to select and/or determine an appropriate DMRS transmission mode, for example based on WTRU measurements and/or configured conditions.

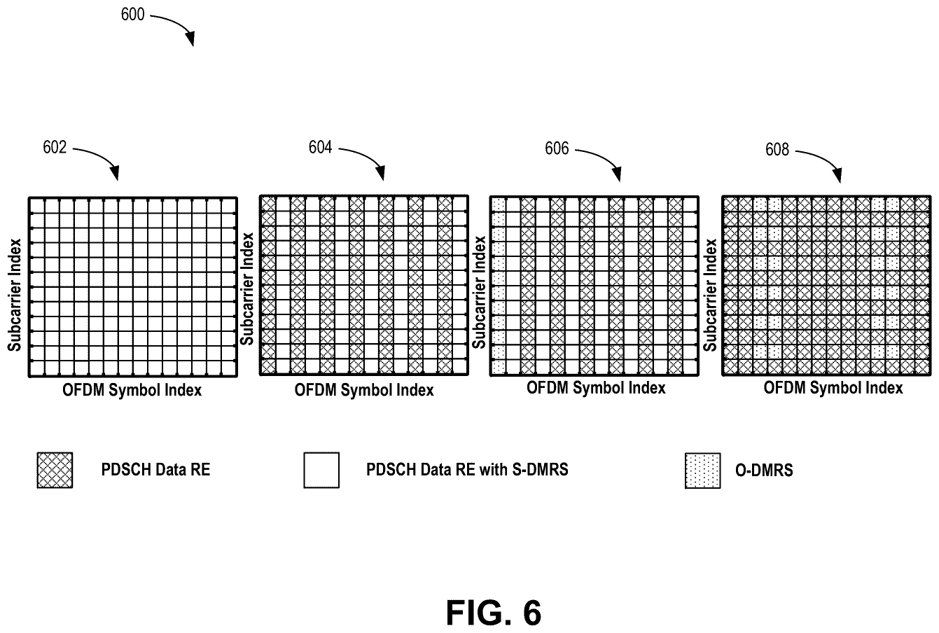

FIG. 6 is an example of different modes 600. A WTRU may be configured with multi-mode PDSCH transmission. The PDSCH transmission may include one or more multiplexed DMRS-based modes, for example according to DMRS transmission mode(s), a configured power ratio a %, a configured overlap factor, a configured multimode multiplexing ratio, and/or conditions/criterions to enable multimode DMRS-based operation. The DMRS transmission mode may include a fully S-DMRS mode 602 (e.g., default), a partially S-DMRS mode 604, a multimode/partially S-DMRS and/or O-DMRS (e.g., legacy) mode 606, and/or a O-DMRS (e.g., legacy) mode 608.

A configured power ratio (e.g., a %) may include a power ratio between S-DMRS relative to data. The configured power ratio may be configured using a predefined/default configuration (e.g., a function of a number of allocated RBs) and/or a granular configuration (e.g., a set of defined values or set of increments/decrements relative to the default value).

A configured overlap factor (e.g., (%) may include an overlap factor between S-DMRS and data symbols. The configured overlap factor may be configured using a predefined configuration (e.g., a function of a number of allocated RBs and/or reported channel conditions) and/or a granular overlap configuration. The granular overlap configuration may include a set of possible overlap formats. For example each format may be represented in terms of starting RE, size of the region and density, and/or pseudorandom-based generation.

A configured multimode multiplexing ratio may define the multiplexing ratio between partially S-DMRS and O-DMRS. The configured multimode multiplexing ratio may include a set of predefined values with predefined locations, for example front-loaded O-DMRS with different density and/or length. Conditions/criterions to enable multimode DMRS-based operation may include Doppler and/or delay spread threshold.

The WTRU may receive a PDSCH associated with a first DMRS transmission mode, for example fully superimposed DMRS. For example, the WTRU may receive the PDSCH associated with a first DMRS transmission mode in a field in DCI. The field may indicate one of multiple PDSCH formats, for example based on the configured mode. For example a first DCI format may indicate front-loaded O-DMRS and/or partially S-DMRS allocated every other OFDM symbol. A second DCI format may indicate fully S-DMRS allocated across REs, for example all REs.

The WTRU may decode the received PDSCH associated with the first DMRS transmission mode. The WTRU may determine a second DMRS transmission mode, for example for a (e.g., each) layer. The WTRU may determine the second DMRS transmission mode based on WTRU-based measurement(s) and/or an explicit indication (e.g., from a NW and/or in a DCI field).

A WTRU-based measurement may include measured channel parameter(s) compared to a configured threshold, a measured Doppler and/or delay spread, higher/lower values (e.g., indicating higher/lower selectivity resulting in overlap increase/decrease and/or power ratio increase/decrease), a measured SGCS between the estimated channel difference between OFDM symbols (e.g., first and last) and/or between two different RBs (e.g., between nth RB and n+N-th RB and/or based on a QCL-ed CSIRS and DMRS), a measured degree of channel selectivity (e.g., use fully S-DMRS if selectivity exceeds a first threshold and/or use O-DMRS if selectivity is below a threshold), a function of the allocated BW, a function of the computed BLER and/or successfully decoded code block groups, a function of reported layers, and/or a function of the AIML model (e.g., CHEST) performance.

The WTRU may determine the parameter(s) associated with the selected/determined DMRS transmission mode. The parameter(s) may include the power ratio, for example for fully S-DMRS. The parameter(s) may include the power ratio and/or overlap factor, for example for partially S-DMRS. The parameters may include power ratio, overlap factor S-DMRS, and/or multiplexing ratio between S-DMRS and O-DMRS (e.g., based on degree of in-channel selectivity), for example for partially S-DMRS and/or O-DMRS. The parameters (e.g., for partially S-DMRS and/or O-DMRS) may be complexity-based, latency-based (e.g., front-loaded O-DMRS), and/or performance based. For complexity-based for example, the WTRU may reduce the MR (e.g., higher O-DMRS allocations) to reduce the number of CHEST model runs. For performance based for example, the WTRU may use channel estimates from O-DMRS as (e.g., side) information to improve CHEST associated with S-DMRS. Additionally, or alternatively, performance based parameters for example, may be based on a channel selectivity metric. For example a high selectivity may have a higher MR and/or a low selectivity may have a lower MR.

The WTRU may report the determined DMRS transmission mode and/or associated parameters (e.g., multiplexing ratio, power ratio and overlap factor). The WTRU may report the determined DMRS transmission mode and/or associated parameters by deriving a resource for reporting as a function of PDSCH resource and/or an indication in DCI. Additionally, or alternatively, the WTRU may report the determined DMRS transmission mode and/or associated parameters by HARQ Feedback (e.g., implicit and/or explicit).

1. A wireless transmit/receive unit (WTRU) comprising:
a processor configured to:
receive a physical downlink shared channel (PDSCH) transmission comprising data and at least one superimposed demodulation reference signal (S-DMRS), wherein S-DMRS and data are multiplexed on the same resource;
determine at least one S-DMRS parameter associated with the PDSCH transmission, the at least one S-DMRS parameter comprising a transmission power ratio of the S-DMRS to the data and an number of resources of a total number of resources associated with the PDSCH transmission that comprise both the data and the S-DMRS; and
transmit an indication of the at least one S-DMRS parameter.

2. The WTRU of claim 1, wherein the at least one S-DMRS parameter comprises at least one first S-DMRS parameter, the transmission power ratio comprises a first transmission power ratio, and the number of resources comprises a first number of resources, and wherein the processor is configured to:
receive configuration information comprising at least one second S-DMRS parameter, the at least one second S-DMRS parameter comprising a second transmission power ratio of S-DMRS to data, a second number of resources that comprise data and S-DMRS, an S-DMRS configuration type, or an S-DMRS feedback configuration; and
receive the PDSCH transmission based on the at least one second S-DMRS parameter.

3. The WTRU of claim 2, wherein the transmission power ratio of S-DMRS to data is based on a number of allocated resource blocks (RBs) or a predetermined value.

4. The WTRU of claim 2, wherein the number of resources that comprise data and S-DMRS is based on a number of allocated resource blocks (RBs) or an overlap format.

5. The WTRU of claim 1, wherein the processor is configured to measure a channel condition and compare the channel condition to a threshold, wherein the determination of the at least one S-DMRS parameter is based on the comparison of the channel condition to the threshold.

6. The WTRU of claim 5, wherein the channel condition comprises a Doppler value or a delay spread value.

7. The WTRU of claim 1, wherein the processor is configured to:
receive configuration information, the configuration information based on the indication of the at least one S-DMRS parameter; and
receive a PDSCH transmission based on the configuration information.

8. The WTRU of claim 1, wherein the processor is configured to use an artificial intelligence (AI) machine learning (ML) model to estimate a channel condition for the resources that comprise data and S-DMRS.

9. The WTRU of claim 1, wherein the processor is configured to transmit the indication of the at least one S-DMRS parameter based on a predetermined change in a channel parameter.

10. The WTRU of claim 1, wherein the PDSCH transmission comprises a first resource comprising orthogonal DMRS (O-DMRS) and a second resource comprising data and S-DMRS.

11. A method performed by a wireless transmit/receive unit (WTRU), the method comprising:
receiving a physical downlink shared channel (PDSCH) transmission comprising data and at least one superimposed demodulation reference signal (S-DMRS), wherein S-DMRS and data are multiplexed on the same resource;
determining at least one S-DMRS parameter associated with the PDSCH transmission, the at least one S-DMRS parameter comprising a transmission power ratio of the S-DMRS to the data or an number of resources of a total number of resources associated with the PDSCH transmission that comprise both the data and the S-DMRS; and
transmitting an indication of the at least one S-DMRS parameter.

12. The method of claim 11, wherein the at least one S-DMRS parameter comprises at least one first S-DMRS parameter, the transmission power ratio comprises a first transmission power ratio, and the number of resources comprises a first number of resources, and wherein the method comprises:
receiving configuration information comprising at least one second S-DMRS parameter, the at least one second S-DMRS parameter comprising a second transmission power ratio of S-DMRS to data, a second number of resources that comprise data and S-DMRS, an S-DMRS configuration type, or an S-DMRS feedback configuration; and
receiving the PDSCH transmission based on the at least one second S-DMRS parameter.

13. The method of claim 12, wherein the transmission power ratio of S-DMRS to data is based on a number of allocated resource blocks (RBs) or a predetermined value.

14. The method of claim 12, wherein the number of resources that comprise data and S-DMRS is based on a number of allocated resource blocks (RBs) or an overlap format.

15. The method of claim 11, comprising measuring a channel condition and comparing the channel condition to a threshold, wherein the determination of the at least one S-DMRS parameter is based on the comparison of the channel condition to the threshold.

16. The method of claim 15, wherein the channel condition comprises a Doppler value or a delay spread value.

17. The method of claim 11, comprising:
receiving configuration information, the configuration information based on the indication of the at least one S-DMRS parameter; and
receiving a PDSCH transmission based on the configuration information.

18. The method of claim 11, comprising using an artificial intelligence (AI) machine learning (ML) model to estimate a channel condition for the resources that comprise data and S-DMRS.

19. The method of claim 11, comprising transmitting the indication of the at least one S-DMRS parameter based on a predetermined change in a channel parameter.

20. The method of claim 11, wherein the PDSCH transmission comprises a first resource comprising orthogonal DMRS (O-DMRS) and a second resource comprising data and S-DMRS.
